(19) United States
(12) Patent Application Publication
(10) Pub. No.: US 2005/0167403 A1
(43) Pub. Date: Aug. 4, 2005

(54) Laser material machining using hybrid processes

(75) Inventor: Dirk Petring, AE Kerkrade (NL)

Correspondence Address: GUDRUN E. HUCKETT DRAUDT, LONSSTR. 53, WUPPERTAL, 42289, DE

(73) Assignee: Fraunhofer-Gesellschaft zur Forderung der angewandten Forschung e.V., Munchen (DE)

(21) Appl. No.: 10/511,296

(22) PCT Filed: Apr. 17, 2003
(86) PCT No.: PCT/DE03/01302

(30) Foreign Application Priority Data
Apr. 19, 2002 (DE) 102 17 678.7

(51) Int. Cl. B23K 26/00

(52) U.S. Cl. 219/121.6

(57) ABSTRACT

In a method for machining workpieces by combining a first machining tool with at least one second machining tool, wherein at least one of the first and second machining tools employs laser radiation, the first machining tool is operated with a first pulse modulation and the at least one second machining tool is operated with a second pulse modulation. The first and second pulse modulations are synchronized. Same pulse frequencies can be used for the first and second pulse modulations, or, in the alternative, pulse frequencies are used that are an integral multiple relative to one another, wherein the first and second pulse modulations are in a fixed or variably controlled phase relationship relative to one another.

The invention relates to a method for the machining of materials by combining one machining tool with at least one additional machining tool, wherein at least one machining tool employs laser radiation.

Such methods and devices for material machining, in which at least one machining tool in the form of a laser beam is used in combination with other machining tools, for example, laser beams and/or electric arcs and/or plasma beams and/or one or several other energy or particle beams, for example, flame, cutting tools, water jet, electron beams, are known. As representative examples in this context, publications, patent applications, and patents of Fraunhofer ILT concerning so-called laser-electric arc hybrid welding can be referenced.

The hybrid technology is based on the combination of laser beam welding with metal shielding gas welding of metals, in the following referred to as MSG, i.e., metal inert gas welding, in the following referred to as MIG, or metal active gas welding, in the following referred to as MAG, or with tungsten inert gas welding in the following referred to as TIG.

In this connection, reference is being had to the following patents:
Nozzle arrangement for simultaneous welding with laser beam and electric arc (DE 196 27 803 C1);
Method for welding workpieces (DE 195 00 512);
Method for welding workpieces with laser radiation (EP 0 800 434 B1).

In the following examples of the prior art, the depth welding effect of the focused laser radiation is combined with additional energy and, in the case of shielding gas welding, also with additional material supply from an electric arc. Additional energy and possibly additional material serve, for example, for bridging the joining gaps or for compensating edge displacement. The effectiveness, the productivity, and the quality of the hybrid process are superior to the properties of the individual processes.

A further possibility uses the combination of different laser beam sources, for example, strongly focused CO₂ laser radiation with diode laser radiation having larger, for example, linear or annular, active surfaces, in order to achieve a preheating or post-heating of the material or an enlargement of the melted volume and, accordingly, a better degassing thereof; compare, for example, S. Bouss, B. Brenner, E. Beyer: Innovations in laser hybrid technology; Industrial Laser Solutions; January 2001, Penn Well. Also, one patent of Fraunhofer ILT employs for consumption-stabilized flame cutting the combination of several laser beams or the combination of laser radiation with other energy sources (DE 41 15 561 C2).

Moreover, when exclusively being used for material machining or in hybrid combination with other tools, methods of laser material machining as well as electric arc processes, for example, MIG/MAG or TIG, currently employ occasionally already the possibility of pulse modulation for a temporal control of the machining process. Certain laser source types, however, are not able to perform in permanent operation; they can also can only be used in pulsed operation.

Pulse modulation of radiation, electric arc, plasma or other energy, pulse, or particle sources, for example, flame, cutting tools, waterjet, electric beam, serve, for example, the following purposes in the individual processes:
targeted influencing of interaction time,
metered and portioned energy introduction,
metered, portioned material removal (for example, during percussion drilling),
gentle material machining with reduced heat-affected zone by employing short pulse-on and pulse-off times,
safe droplet removal (MSG),
improved material transition (MSG),
minimization of spatter,
process stabilization in otherwise instable working areas, for example, exothermic over reaction during flame cutting with heat build-up, unsteady transition arc during inert gas welding in medium current intensity range,
increase of energy flux density in the pulse for average current density and path energy that are reduced or identical in comparison to permanent operation, and
short-term increase of processing temperature and/or evaporation proportion in the interactive zone.

In the presently known technologies, primarily the limitations regarding the possibility of affecting the degree of coupling of the individual methods when combining them to a hybrid process have been perceived as a disadvantage.

In the past, for determining the degree of coupling primarily the spacing or the degree of overlap of the active area has been used. In order to reinforce, for example, coupling of laser beams and electric arc, their roots on the workpiece have been moved closer together. In order to suppress the coupling, the roots are moved apart from one another. However, at the same time, the size and shape of the interaction geometry and the effective reaction time are changed; in certain situations this can be very disadvantageous. This will be explained in more detail with the aid of some examples.

Especially when using CO₂ lasers, care must be taken to avoid plasma shielding of the laser radiation in the electric arc or plasma. However, at the same time, guiding and/or concentration of the electric arc by the focused laser beam is desirable. Accordingly, goals are present that negatively affect one another.

The same can hold true for the combination, for example, of the wavelength of different laser radiations, when, for example, a strong coupling, on the one hand, is advantageous for utilizing the absorption-increasing effect on the workpiece, for example, by generating periodic surface structures, but, on the other hand, a strong coupling leads to disruptions of at least one of the methods, for example, in that its laser radiation is absorbed or scattered by the material vapor above the workpiece caused by the other laser radiation.

It is an object of the invention to provide a method and a device of the aforementioned kinds that enables with technically simple means to make the degree of coupling, and optionally also the coupling type, of the effect of the individual methods in the employed hybrid technology electronically adjustable in a targeted and variable way.

This object is solved for a method of the aforementioned kind in accordance with the invention in that a synchronized modulation, i.e., synchronous or a synchronous modulation, of the first machining tool is carried out when combining it with the additional machining tool that is also pulse-modulated.

According to the invention, the degree of coupling and optionally also the coupling type become adjustable in a targeted and variable way electronically without mechanical adjustments on the tool for the effect of the individual methods in the employed hybrid technology, primarily without mandatorily having to use a change of the local spacing of the interactive areas of the individual methods on or within the workpiece and without having to abandon space adjustments that may be useful for other reason, for example, the spacing zero. The tool components are therefore synchronized in a targeted way.

According to one embodiment of the invention, it is provided that the first machining tool and the at least one additional machining tool are modulated with the same pulse frequence or with pulse frequencies that are an integral multiple relative to one another and that their pulse modulations are in a fixed or variably controlled or governed phase relation to one another.

A particularly simple control of the modulation is provided when the pulse control signals of at least one pulse-modulated machining tool are used as master signal for triggering a synchronized control of the pulse modulation of at least one additional machine-tool in slave operation.

In order to be able to react faster and also simpler to changes in the process course and also for the input, it is advantageous when the phase relationship is controlled and/or governed as a function of and/or for affecting one or several process parameters and/or as a function of sensor signals.

A further embodiment of the invention provides that in-phase synchronization is carried out. However, it is also possible that an antiphase synchronization is carried out.

A particularly simple synchronization can be achieved when the slave pulse is generated at the beginning or the end of the master pulse or vice versa.

Moreover, it is provided that individual pulses or pulse packages are generated.

Moreover, it is advantageous when the controllable radiation, which is optionally not externally controlled, i.e., not from outside the tool control, or the machining tool or the process-controlled machining tool that is internally process-controlled by variable pulse frequency is the master. The lafter, for example, can be used for modern digital current sources of electric arc processes or rotating cutting tools, for example, milling tools, whose rotary frequency is to be understood in this context as the pulse frequency.

Moreover, it is provided that the additional machining tool is a laser device and/or an electric arc radiation device and/or a plasma radiation device and/or one or several other energy, pulse, or particle sources.

A further advantageous method is provided in that the machining of workpieces can be selected from the following list:
separation or removal methods, in particular, cutting, drilling, material removal, perforations, scoring, engraving, structuring, or cleaning;
joining methods, in particular, welding, soldering or bonding,
coating and building processes, in particular, coating, generating, selective sintering, or rapid prototyping,
surface treatment and surface finishing, in particular, hardening, refining, alloying, dispersing, polishing and applying lettering, shaping, and bending,
   wherein the combination of the machining tools is configured such that their active areas that can be exposed optionally to effects of different kinds, on or within the workpiece overlap or adjoin one another immediately during the machining process.

Moreover, the object is solved for a device of the aforementioned kind in accordance with the invention by a first pulse generator for modulation of the laser radiation, by a second pulse generator for modulation of the additional machining tool, and by a synchronizer for a synchronous modulation of the combination.

Advantageous embodiments of the device according to the invention are detailed in the dependent claims. Since these dependent claims correspond essentially to the dependent claims that further define the method, a detailed description thereof is not provided here.

Further features and advantages of the invention result from the following description of several embodiments as well as the drawings to which reference is being had. It is shown in:

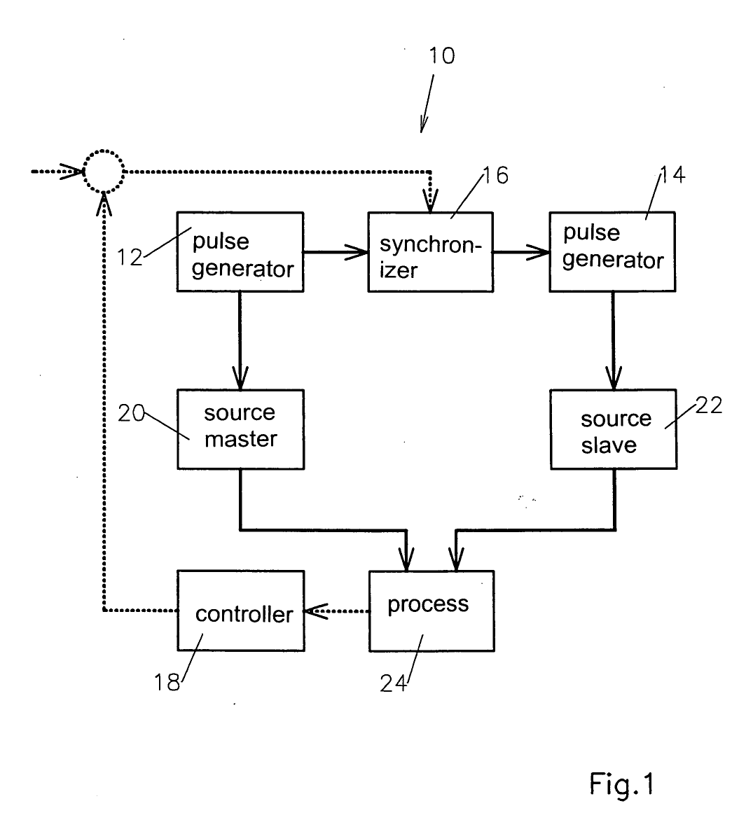

FIG. 1 a block diagram of a master-slave triggering action for the synchronization of the pulse modulation with fixed or controlled phase relationship; and

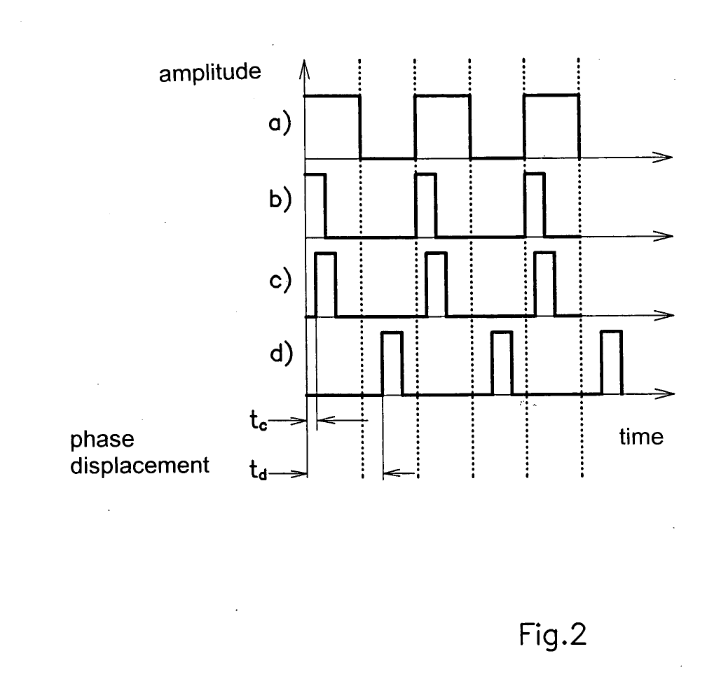

FIG. 2 several diagrams as examples for characteristic phase relationships for synchronized pulse modulation in hybrid processes.

Based on FIGS. 1 and 2, methods and devices for hybrid processing of materials by combining a machining tool with at least one additional machining tool will be explained, wherein at least one machining tool employs laser radiation.

In FIG. 1, schematically a device 10 for hybrid processing of materials by a machining tool in combination with at least one additional machining tool is illustrated. The device 10 comprises in the illustrated embodiment a first pulse generator 12 for modulation of a laser radiation as a machining tool. Moreover, the device 10 comprises a second pulse generator 14 for modulation of the additional machining tool 12.

Between the first pulse generator 12 and the second pulse generator 14 a synchronizer 16 is connected that, in the device 10 illustrated in FIG. 1, receives output values of the first pulse generator 12 and inputs, in turn, output values into the second pulse generator 14. Moreover, the synchronizer 16 receives input values that are illustrated in FIG. 1 by a dotted line.

Furthermore, the first pulse generator 12 also supplies output values to the first source 20 that, in the illustrated embodiment, is used as a master signal. In some cases, it can be more advantageous to employ the source 22 of the additional machining tool as a master.

In a similar way, the second pulse generator 14 provides output values to a second source 22 that, in the illustrated embodiment, is used as a slave signal for the slave operation.

Accordingly, by means of the first and the second sources 20 and 22, pulse control signals of at least one pulse generator 12 are processed as a master signal for triggering a synchronous control of the pulse modulation of the pulse control signals of the at least one additional pulse generator 14 in slave operation.

As indicated in FIG. 1, there are input devices for process parameters as well as sensors for process results for controlling and/or governing the phase relationship as a function of and/or for affecting one or several process parameters and/or as a function of sensors signals.

The output signals of the first source 20 and of the second source 22, respectively, are employed for the process operation; this is indicated in FIG. 1 by the box “process” identified by reference numeral 24.

The above-mentioned sensor signals are supplied to a controller 18 that is connected, in turn, to an input device and accordingly also to the synchronizer 16 through the input device.

The first and second pulse generators 12 and 14 and the synchronizer 16 are therefore designed to modulate the laser radiation and the at least one additional machining tool by pulse frequencies that are an integral multiple relative to one another and put the pulse modulations of the first and second pulse generators 12 and 14 in a fixed or in variable phase relationship variably controlled or governed by the controller 18.

Inter alia, the synchronizer 16 can also be designed for an in-phase synchronization. It is also possible to design the synchronizer 16 for an antiphase synchronization. Finally, there is also the possibility to use the synchronizer 16 for generating a slave pulse at the beginning or the end of the master pulse or vice versa.

In this connection, the first and second pulse generators 12 and 14 can be designed such that they generate individual pulses and/or pulse packages.

In FIG. 2, several diagrams as examples for characteristic phase relationships for synchronized pulse modulation in hybrid methods are illustrated. The diagram referenced at a) represents the modulation of the master. The diagram b) represents the in-phase slave modulation.

The diagram c) shows that it is also possible to employ slave modulation with minimal phase displacement, in this case displaced by t_{c}. This means that a finite temporal overlap of the pulse-on times occurs but can also mean a common pulse drop time together with the master for a shorter pulse-on time of the slave. Finally, the diagram d) provides an antiphase slave modulation. This provides no temporal overlap of the pulses; the pulses however can also follow in direct sequence. In the diagram d) there is a phase displacement of t_{d}.

In general, it can be stated that a targeted adjustment of the process cycle by adjusted synchronization is possible. Examples of the process cycle are courses over time of temperature, natural voltage, reaction, material application, material removal, material bonding, material separation, as well as phase transition.

A strong coupling, i.e., an in-phase synchronized pulse modulation, effects an improvement of the depth welding effect of the laser, an improvement of the pinch effect for droplet removal of the MIG process as well as an improvement of the electric arc guiding and contraction by means of a focused laser.

A decoupling, i.e., an antiphase synchronized modulation, has advantageous effects on preventing laser beam shielding and/or scattering and/or refraction within the electric arc plasma. The temporal separation and thus capillary formation and droplet removal with material transfer during laser-MIG hybrid welding are possible also in this connection.

Also possible is an adjusted coupling, i.e., a targeted phase displacement of the synchronous pulse modulation of one tool component or of a radiation. Examples for this are threshold-dependent partial processes that only upon reaching or surpassing a process threshold become effective with the corresponding phase-delayed post-pulse by means of the pre-pulse of the other tool component or the at least one additional radiation. The phase delay is varied in this connection for optimizing the type of action, the efficiency, the productivity, the stability, as well as the quality of the hybrid process.

The additional machining tool can be a laser radiation and/or an electric arc radiation and/or a plasma radiation and/or one or several other energy, pulse, or particle sources.

In the following several effects will be described, in particular, the pre-pulsing by a laser, pre-pulsing by an electric arc or plasma beam as well as post pulsing.

The effects of pre-pulsing by a laser are as follows:
preheating, for example, for improved wettability of materials or for metallurgical adjustment of the process,
cleaning,
layer removal,
pre-ionization,
chemical activation,
pre-melting (preprocessing).

The effects and results of pre-pulsing by an electric arc or plasma beam are as follows:
preheating,
absorption increase for the laser beam by surface changes, for example, by changing the temperature, structure, material, and/or by chemical reaction,
absorption increase for the laser beam by changing the atmosphere near the surface and thus the relative refractive index,
portioned energy and material supply, for example, for bridging joining gaps.

Post-pulsing can have the following effects or results:
post-heating,
surface finishing by supplying energy or material,
degassing of the melt during welding and coating,
material removal or material joining after preparation by a pre-pulse,
chemical reaction, for example, joining or separating, after pretreatment by a pre-pulse.

Moreover, it is possible to modulate the following parameters,
output,
current,
voltage,
speed, for example, of the wire feed of the additional material or the electrode that is being consumed,
frequency.

The parameters of modulation can be of the following type:
basic level,
pulse frequency,
pulse length, pulse pause, or pulse-width repetition,
pulse peak value,
duration of the pulse peak value,
temporal course of the pulse rise,
temporal course of the pulse drop.

The invention thus provides the degree of coupling and optionally also the type of coupling for the effect of the individual methods in employed hybrid technology and enables variable adjustment electronically without mechanical adjustment of the tool. Primarily without mandatorily having to use a change of the local spacing of the interactive areas of the individual methods on or within the workpiece and without having to abandon space adjustments that may be useful for other reason, for example, the spacing zero. Moreover, it is possible, where it is advantageous, to increase the coupling past the level that is already provided alone by complete overlapping of the interactive zones or the identical roots of the individual processes on or within the workpiece. On the other hand, the invention also makes possible in this configuration a substantial decoupling of individual processes, inasmuch as this is desirable for the hybrid process effect.

List of Reference Numerals
10 device
12 first pulse generator
14 second pulse generator
16 synchronizer
18 controller
20 first source
22 second source
24 process

1.-21. (canceled)

22. A method for machining workpieces by combining a first machining tool with at least one second machining tool, wherein at least one of the first and second machining tools employs laser radiation, the method comprising the steps of:
operating the first machining tool with a first pulse modulation and the at least one second machining tool with a second pulse modulation; and
synchronizing the first and second pulse modulations of the first machining tool and the at least one second machining tool.

23. The method according to claim 22, wherein in the step of synchronizing same pulse frequencies are used for the first and second pulse modulations, wherein the first and second pulse modulations are in a fixed or variably controlled phase relationship relative to one another.

24. The method according to claim 22, wherein in the step of synchronizing pulse frequencies are used that are an integral multiple relative to one another, wherein the first and second pulse modulations are in a fixed or variably controlled phase relationship relative to one another.

25. The method according to claim 22, wherein in the step of synchronizing one of the first and at least one second machining tools is used as a master and the other or others of the first and at least one second machining tools are slaves, wherein pulse control signals of the master are used as a master signal for synchronizing the first and second pulse modulations.

26. The method according to claim 23, wherein the phase relationship is controlled as a function of one or several process parameters and/or for affecting one or several process parameters and/or as a function of sensor signals.

27. The method according to claim 24, wherein the phase relationship is controlled as a function of one or several process parameters and/or for affecting one or several process parameters and/or as a function of sensor signals.

28. The method according to claim 22, wherein the step of synchronizing is carried out by in-phase synchronization.

29. The method according to claim 22, wherein the step of synchronizing is carried out by antiphase synchronization.

30. The method according to claim 25, wherein a slave pulse in response to the master pulse is generated at the beginning or at the end of the master pulse, or vice versa.

31. The method according to claim 22, further comprising the step of generating individual pulses or pulse packages for the first and second pulse modulations.

32. The method according to claim 25, wherein the master is a machining tool that is optionally not externally controllable.

33. The method according to one claim 25, wherein the master is a machining tool that is internally process-controlled with variable pulse frequency.

34. The method according to claim 22, wherein the at least one second machining tool employs at least one of laser radiation, electric arc radiation, plasma radiation, an energy source, a pulse source, and a particle source.

35. The method according to claim 22, wherein the first and second machining tools are selected from the group consisting of separating tools, material removing tools, joining tools, coating tools, building tools, surface treatment tools, and surface finishing tools, wherein the first and at least one second machining tools are configured such that active areas during machining on or within the workpiece overlap or adjoin one another immediately during the machining process.

36. The method according to claim 35, wherein the first and second machining tools perform machining processes selected from the group consisting of cutting, drilling, material removing, perforating, scoring, engraving, structuring, cleaning, welding, soldering, bonding, coating, generating, selective sintering, rapid prototyping, hardening, refining, alloying, dispersing, polishing, applying lettering, shaping, and bending.

37. A device for hybrid processing of materials by a first machining tool in combination with at least one second machining tool, wherein the first machining tool employs laser radiation, the device comprising:
a first pulse generator for pulse modulation of the laser radiation of the first machining tool;
a second pulse generator for pulse modulation of the at least one second machining tool;
a synchronizer for synchronous modulation of the first and the at least one second machining tool.

38. The device according to claim 37, further comprising a controller, wherein the first and second pulse generators and the synchronizer are designed to modulate the laser radiation and the at least one additional machining tool with same pulse frequencies, wherein the pulse modulations of the first and second pulse generators are in a fixed or variable phase relationship that is variably controlled by the controller.

39. The device according to claim 37, further comprising a controller, wherein the first and second pulse generators and the synchronizer are designed to modulate the laser radiation and the at least one additional machining tool with pulse frequencies that are an integral multiple relative to one another, wherein the pulse modulations of the first and second pulse generators are in a fixed or variable phase relationship that is variably controlled by the controller.

40. The device according to claim 37, further comprising at least one source for processing pulse control signals generated by the first pulse generator as a master signal for triggering a synchronous control of the modulation of pulse control signals of the second pulse generator in slave operation.

41. The device according to claim 37, further comprising at least one source for processing pulse control signals generated by the second pulse generator as a master signal for triggering a synchronous control of the modulation of pulse control signals of the first pulse generator in slave operation.

42. The device according to claim 37, further comprising input devices for process parameters and sensors for process results in the form of sensor signals, wherein the input devices and the sensors are configured to control a phase relationship of the pulse modulations as a function of the process parameters and/or for affecting one or several of the process parameters and/or as a function of the sensors signals.

43. The device according to claim 37, wherein the synchronizer provides in-phase synchronization.

44. The device according to claim 37, wherein the synchronizer provides antiphase synchronization.

45. The device according to claim 37, wherein the synchronizer generates a slave pulse at the beginning or at the end of the master pulse.

46. The device according to claim 37, wherein the first and second pulse generators generate individual pulses and/or pulse packages.

47. The device according to claim 37, wherein the at least one second machining tool employs at least one of laser radiation, electric arc radiation, plasma radiation, an energy source, a pulse source, and a particle source.
